(19) United States
(12) Patent Application Publication
(10) Pub. No.: US 2014/0050992 A1
(43) Pub. Date: Feb. 20, 2014

(54) COMPOSITE MATERIALS FOR LITHIUM-SULFUR BATTERIES

(71) Applicant: BASF SE, Ludwigshafen (DE)

(72) Inventors: Alexander PANCHENKO, Ludwigshafen (DE); Evgueni Klimov, Ludwigshafen (DE); Oliver Gronwald, Frankfurt (DE); Klaus Leitner, Ludwigshafen (DE); Peter Przybylski, Ludwigshafen (DE)

(73) Assignee: BASF SE, Ludwigshafen (DE)

(21) Appl. No.: 13/965,509

(22) Filed: Aug. 13, 2013

Related U.S. Application Data
(60) Provisional application No. 61/682,786, filed on Aug. 14, 2012.

(51) Int. Cl. H01M 4/133; H01M 4/36; H01M 4/1393; H01M 10/058; H01M 4/136; H01M 10/056

(52) U.S. Cl. CPC H01M 4/133; H01M 4/136; H01M 10/056; H01M 4/1393; H01M 10/058; H01M 4/364
USPC 429/338; 429/231.8; 429/207; 429/342; 429/343; 29/623.1; 252/502; 252/511

(57) ABSTRACT

The present invention relates to sulfur-carbon composite materials comprising

(A) at least one carbon composite material comprising
(a) a carbonization product of at least one carbonaceous starting material, incorporating
(aa) particles of at least one electrically conductive additive, the particles having an aspect ratio of at least 10,
   and
   (B) elemental sulfur.

In addition, the present invention also relates to a process for producing inventive sulfur-carbon composite materials, to cathode materials for electrochemical cells comprising inventive sulfur-carbon composite materials, to corresponding electrochemical cells and to the use of carbon composite materials for production of electrochemical cells.

The present invention relates to sulfur-carbon composite materials comprising

(A) at least one carbon composite material comprising
(a) a carbonization product of at least one carbonaceous starting material, incorporating
(aa) particles of at least one electrically conductive additive, the particles having an aspect ratio of at least 10,
   and
   (B) elemental sulfur.

In addition, the present invention also relates to a process for producing inventive sulfur-carbon composite materials, to cathode materials for electrochemical cells comprising inventive sulfur-carbon composite materials, to corresponding electrochemical cells and to the use of carbon composite materials for production of electrochemical cells.

Storing energy has long been a subject of growing interest. Electrochemical cells, for example batteries or accumulators, can serve to store electrical energy. As of recently, what are called lithium ion batteries have attracted particular interest. They are superior to the conventional batteries in several technical aspects. For instance, they can be used to generate voltages unobtainable with batteries based on aqueous electrolytes.

However, the energy density of conventional lithium ion accumulators which have a carbon anode and a cathode based on metal oxides is limited. New dimensions with regard to energy density are being opened up by lithium-sulfur cells. In lithium-sulfur cells, sulfur is reduced in the sulfur cathode via polysulfide ions to S²⁻, which is oxidized again as the cell is charged to form sulfur-sulfur bonds. In the course of the charging and discharging operations, the structure of the cathode accordingly changes, which corresponds at the macroscopic level to expansion and shrinkage, i.e. a change in the volume, of the cathode.

As well as the sulfur, the cathode in a lithium-sulfur cell typically also comprises carbon black or carbon black mixtures as conductive additives, and binders. The binders typically present in the cathodes of lithium-sulfur cells serve firstly to contact the carbon black particles, which are electrically conductive, with the electrochemically active sulfur, which is not itself electrically conductive, and secondly for connection of the sulfur-carbon black mixture to the output materials of the cathode, for example metal foils, metal meshes or metal-coated polymer films.

WO 2009/054987 describes polyvinyl alcohol as a primer layer on an aluminum layer, the aluminum layer serving as a conductor, also called current collector, for a sulfur cathode.

In US 2010/0239914 and US 2011/0059361, cathodes for lithium-sulfur cells are produced in each case using polyvinyl alcohol as a binder, by bonding sulfur and soot particles with polyvinyl alcohol.

The sulfur-containing cathode materials described in the literature still have shortcomings with regard to one or more of the properties desired for cathode materials and the electrochemical cells produced therefrom. Desirable properties are, for example, good adhesion capacity of the cathode materials to the output materials, high electrical conductivity of the cathode materials, a rise in the cathode capacity, an increase in the lifetime of the electrochemical cell, an improvement in the mechanical stability of the cathode or a reduced change in volume of the cathodes during a charge-discharge cycle. In general, the desired properties mentioned also make a crucial contribution to improving the economic viability of the electrochemical cell, which, as well as the aspect of the desired technical performance profile of an electrochemical cell, is of crucial significance to the user.

It was thus an object of the present invention to provide an inexpensive cathode material for a lithium-sulfur cell, which has advantages over one or more properties of a known cathode material, more particularly a cathode material which enables the construction of cathodes with an improved electrical conductivity, combined with high cathode capacity, high mechanical stability and long lifetime.

This object is achieved by a sulfur-carbon composite material comprising

(A) at least one carbon composite material comprising
(a) a carbonization product of at least one carbonaceous starting material, incorporating
(aa) particles of at least one electrically conductive additive, the particles having an aspect ratio of at least 10,
   and
   (B) elemental sulfur.

The inventive sulfur-carbon composite materials are composite materials. Composite materials are generally understood to mean materials which are solid mixtures which cannot be separated manually and which have different properties than the individual components. Specifically, the inventive sulfur-carbon composite materials are particle composite materials, especially fiber composite materials.

The inventive sulfur-carbon composite material comprises, as component (A), at least one carbon composite material, also referred to hereinafter as carbon composite (A) for short, which comprises, as component (a), a carbonization product of at least one carbonaceous starting material, also referred to hereinafter as carbonization product (a) for short, incorporating, as component (aa), particles of at least one electrically conductive additive, also referred to hereinafter as particles (aa) for short, where the particles (aa) have an aspect ratio of at least 10. In addition, the inventive sulfur-carbon composite material comprises, as component (B), elemental sulfur, also referred to hereinafter as sulfur (B) for short.

The carbonization product (a) present in the carbon composite (A), which is a solid, can be produced from various carbonaceous starting materials. Both the production process for carbonization products and the suitable carbonaceous starting materials usable in the production processes are known in principle to those skilled in the art. Carbonization products typically form as solid, carbon-rich residues in the pyrolysis of carbonaceous starting materials with supply of heat and complete or at least substantially complete exclusion of oxygen, in order to as far as possible prevent the oxidation of the carbon from the carbonaceous starting materials to carbon monoxide or carbon dioxide. Known carbonization products from pyrolysis processes are, for example, wood charcoal, animal charcoal, coke from brown coal or hard coal, or carbon fibers formed from polyacrylonitrile. The carbonization product (a) can also be referred to as a carbon matrix obtainable by pyrolysis of a carbonaceous starting material.

Carbonaceous starting material is preferably selected from carbohydrates, resins, coke, pitch, polyacrylonitrile, styrene-acrylonitrile copolymers, melamine-formaldehyde resins and phenol-formaldehyde resins. Preferred carbonaceous starting materials are especially carbohydrates, especially mono-, di- or polysaccharides, in which, in a formal sense, solely elimination of water leaves carbon. The carbohydrate is most preferably starch.

In one embodiment of the present invention, a feature of the inventive sulfur-carbon composite material is that the carbonaceous starting material is selected from carbohydrates, resins, coke, pitch, polyacrylonitrile, styrene-acrylonitrile copolymers, melamine-formaldehyde resins and phenol-formaldehyde resins, especially from carbohydrates.

The carbon content of the carbonization product (a) is preferably more than 80% by weight, more preferably more than 90% by weight, especially more than 95% by weight to a maximum of nearly 100% by weight, based on the mass of the carbonization product (a) determined by elemental analysis.

The particles (aa) present in the carbon composite (A) have an aspect ratio of at least 10, preferably at least 20, more preferably at least 40, especially at least 80. The aspect ratio of a particle is understood to mean the ratio of the length of the particle to the thickness of the particle. Particles having an aspect ratio of at least 10 may accordingly take the form of fibers or leaflets. The particles (aa) of at least one electrically conductive additive are preferably fibrous, in which case the thickness of a fiber is better referred to as the diameter thereof.

The length and diameter of the particles, especially of the fibers, are determined with the aid of scanning electron micrographs or light micrographs. The values thus determined are used to calculate the aspect ratio.

The thickness, or the mean diameter of the particles of the electrically conductive additive, can in principle be varied within a wide range. The particles of the electrically conductive additive preferably have a thickness or more particularly a mean diameter in the range from 50 nm to 100 μm, more preferably in the range from 60 nm to 1000 nm, especially in the range from 70 nm to 200 nm.

The mean diameter of the particles is, as described above, determined with the aid of scanning electron micrographs or light micrographs.

In one embodiment of the present invention, a feature of the inventive sulfur-carbon composite material is that the particles of the electrically conductive additive have a mean diameter of 50 nm to 100 μm.

The particles of the electrically conductive additive preferably have an electrical conductivity in the range from 0.1 mS/cm to 30 000 S/cm, more preferably in the range from 100 mS/cm to 30 000 mS/cm.

The electrical conductivity LF of the additive is determined by pressing the additive in a standard press mold as used for the production of KBr disks to give a pellet having the thickness d and the cross-sectional area A. This pellet is then clamped between two gold metal plates and analyzed by means of electrical impedance spectroscopy. The real part Re of the impedance (in the high-frequency range at 1-10 kHz) is used to calculate the electrical conductivity LF according to: LF=d/(A×Re).

In one embodiment of the present invention, a feature of the inventive sulfur-carbon composite material is that the particles of the electrically conductive additive have an electrical conductivity of 0.1 mS/cm to 30 000 S/cm.

Suitable particles of an electrically conductive additive are known in principle to those skilled in the art. The particles of the electrically conductive additive are preferably selected from carbon fibers, fibers of transparent metal oxides selected from indium tin oxide, Al-doped zinc oxide, Ga-doped zinc oxide, In-doped zinc oxide, F-doped tin dioxide, Sb-doped tin dioxide, fibers of metal carbides selected from WC, MoC and TiC, and metal fibers selected from aluminum and steel. The particles of the electrically conductive additive are more preferably carbon fibers.

Processes for preparing particles of an electrically conductive additive, especially fibers of an electrically conductive additive, are known in principle to those skilled in the art. For example, it is possible to obtain carbon fibers by pyrolysis of polyacrylonitrile fibers. Carbon fibers are commercially available from a number of suppliers. Fibers of transparent metal oxides, for example Al-doped zinc oxide or Sb-doped tin dioxide, can be produced, for example, by electro-spinning processes and subsequent calcination, as described in WO2010/122049 or WO2011/054701.

In one embodiment of the present invention, a feature of the inventive sulfur-carbon composite material is that the particles of the electrically conductive additive are selected from carbon fibers, fibers of transparent metal oxides selected from indium tin oxide, Al-doped zinc oxide, Ga-doped zinc oxide, In-doped zinc oxide, F-doped tin dioxide, Sb-doped tin dioxide, fibers of metal carbides selected from WC, MoC and TiC, and metal fibers selected from aluminum and steel.

The proportion by weight of the particles of the electrically conductive additive based on the total weight of the carbon composite material (A) can be varied within a wide range. The proportion by weight of the particles of the electrically conductive additive based on the total weight of the carbon composite material (A) is preferably in the range from 0.1 to 60% by weight, more preferably in the range from 1 to 40% by weight, especially in the range from 5 to 25% by weight.

In one embodiment of the present invention, a feature of the inventive sulfur-carbon composite material is that the proportion by weight of the particles of the electrically conductive additive based on the total weight of the carbon composite material (A) is in the range from 0.1 to 60% by weight.

In a preferred embodiment, the sum of the proportions by weight of carbonization product (a) and of particles of the electrically conductive additive (aa) in the carbon composite (A) is at least 80% by weight, more preferably at least 90% by weight, especially at least 95% by weight to a maximum of nearly 100% by weight. The proportions by weight can be determined by means of elemental analysis, taking account of the chemical composition of the starting components.

In a further embodiment, the carbon composite material (A) comprises a carbonization product (a) which is the carbonization product of a polysaccharide, especially of starch, incorporating particles (aa) at least of one electrically conductive additive which comprises carbon fibers having a mean diameter in the range from 70 nm to 200 nm and an aspect ratio of at least 10, and the sum of the proportions by weight of carbonization product (a) and the carbon fibers used as particles (aa) is more preferably in the range from 95% by weight to 100% by weight.

The carbon content of the carbon composite (A) is preferably more than 80% by weight, more preferably more than 90% by weight, especially more than 95% by weight to a maximum of nearly 100% by weight, based on the mass of the carbon composite (A) determined by elemental analysis.

The inventive sulfur-carbon composite material comprises, as component (B), elemental sulfur, and elemental sulfur is known as such.

The sulfur in the carbon composite (A) is preferably finely and homogeneously distributed. The mean particle size of the sulfur is in the range from 0.1 to 50 μm, preferably in the range from 0.1 to 25 μm, more preferably in the range from 0.1 to 10 μm. The mean particle size of the sulfur in the sulfur-carbon composite material can be determined with the aid of scanning electron micrographs.

The proportion by weight of the sulfur based on the sum of the proportions by weight of the carbon composite material (A) and of the sulfur (B), may be varied within a wide range. The proportion by weight of the sulfur based on the total weight of the carbon composite material and of the sulfur is in the range from 10 to 95% by weight, more preferably in the range from 30 to 90% by weight, especially in the range from 50 to 85% by weight, determined by elemental analysis.

In one embodiment of the present invention, a feature of the inventive sulfur-carbon composite material is that the proportion by weight of the sulfur based on the sum of the proportions by weight of the carbon composite material and of the sulfur is in the range from 10 to 95% by weight.

The carbon composite (A) or the inventive sulfur-carbon composite material can be obtained in different forms depending on the respective production process. Depending on the dimensions of the reactor used, it is possible in principle to produce shaped bodies having spatial dimensions in the range from 0.001 m to 1 m, i.e. shaped bodies having volumes in the range from 10⁻⁹ m³ to 1 m³. By means of known comminution techniques such as crushing, triturating or grinding, however, it is possible to produce particles of the carbon composite (A) or of the inventive sulfur-carbon composite material having average particle diameters in the range from 100 nm to 1000 μm, preferably in the range from 100 μm to 10 μm, more preferably 0.1 to 10 μm. Such finely divided powders consisting of particulate particles are particularly preferred in the context of the present invention.

In one embodiment of the present invention, a feature of the inventive sulfur-carbon composite material is that the sulfur-carbon composite material is in particulate form.

The above-described inventive sulfur-carbon composite material can be produced in different ways. The process for producing the inventive sulfur-carbon composite materials preferably comprises a process step in which a mixture comprising at least one carbonaceous starting material and particles of at least one electrically conductive additive, the particles having an aspect ratio of at least 10, are mixed with one another, preferably mixed homogeneously. In order to ensure this, the starting materials for production of the carbon composite (A) are preferably in the form of powders, which can generally be mixed without any problem. Otherwise, the mixing can also be performed, depending on the shape and the physical properties of the starting materials, for example, in mixers (also called blenders), mills or extruders. The mixing step can be performed with or without the addition of suitable liquids which can preferably be removed without any problem in the subsequent carbonization step.

In a further process step, the mixture comprising the carbonaceous starting material and the particles of an electrically conductive additive are converted by carbonizing to the carbon composite (A), the carbonaceous starting material giving rise to a carbonization product.

In a further process step, the carbon composite material, possibly after a comminution step, is mixed with elemental sulfur. Preference is given to producing a homogeneous mixture of the carbon composite material with the sulfur, preferably sulfur powder.

The present invention further provides a process for producing a sulfur-carbon composite material comprising

(A) at least one carbon composite material comprising
(a) a carbonization product of at least one carbonaceous starting material, incorporating
(aa) particles of at least one electrically conductive additive, the particles having an aspect ratio of at least 10,
   and
   (B) elemental sulfur,
   comprising at least the process steps of
(i) producing a mixture comprising at least one carbonaceous starting material and particles of at least one electrically conductive additive, the particles having an aspect ratio of at least 10,
(ii) carbonizing the carbonaceous starting material to form a carbonization product comprising particles of an electrically conductive additive to give a carbon composite material,
and
(iii) producing a mixture of the carbon composite material obtained in step (ii) and elemental sulfur.

The description and preferred embodiments of the carbonaceous starting material, of the particles (aa), of the carbonization product (a), of the carbon composite material (A) and of the elemental sulfur (B) in the process according to the invention correspond to the above description of these components for the inventive sulfur-carbon composite material.

In process step (i), as described above, a homogeneous mixture of the starting components for the carbon composite material (A) is preferably provided by known mixing processes with or without addition of further assistants pyrolyzable or fully removable in the carbonization step, for example water.

In process step (ii), the carbon composite material (A) is produced by carbonizing the mixture comprising the carbonaceous starting material and the particles of an electrically conductive additive, the carbonaceous starting material being converted to a carbonization product (a). The actual carbonization step (ii) may be preceded by one or more steps for thermal treatment of the mixture of the starting materials at temperatures below 200° C., which may, for example, be a gluing step in the case of moistened starch or drying steps for removal of one or more solvents, for example water.

The terms “carbonizing” and “carbonization” are used synonymously in the context of the present description.

In general, the carbonizing is performed at a temperature in the range from 200 to 2000° C., preferably in the range from 300 to 1600° C., more preferably in the range from 400 to 1100° C., especially in the range from 500 to 900° C.

In one embodiment of the present invention, a feature of the process according to the invention for producing a sulfur-carbon composite material is that, in process step (ii), the carbonizing is performed at at least 500° C., especially in the range from 550 to 700° C.

The duration for the carbonizing can vary within a wide range and depends upon factors including the temperature at which the carbonization is performed. The duration for the carbonization may be from 0.5 to 50 h, preferably from 1 to 24 h, especially 2 to 12 h.

The carbonizing of the mixture comprising the carbonaceous starting material and the particles (aa) can in principle be performed in one or more stages, for example one or two stages. In principle, a carbonization step can be performed in the presence or absence of oxidizing agents, for example oxygen, provided that the oxidizing agent does not fully oxidize the carbon present in the carbonaceous starting material. In order to very substantially suppress the oxidation of the carbon present in the carbonaceous starting material, it has been found to be advantageous to perform the carbonization with substantial or complete exclusion of oxygen, preferably in the presence of inert gases.

The carbonizing of the mixture comprising the carbonaceous starting material and the particles (aa) can in principle be performed under reduced pressure, for example under vacuum, under standard pressure or under elevated pressure, for example in a pressure autoclave. In general, the carbonizing is performed at a pressure in the range from 0.01 to 100 bar, preferably in the range from 0.1 to 10 bar, especially in the range from 0.5 to 5 bar or 0.7 to 2 bar. The carbonizing can be performed in a closed system or in an open system in which volatile constituents which form are removed in a gas stream, inert gases or reducing gases.

In process step (iii), a mixture of the carbon composite material (A) obtained in step (ii) and elemental sulfur (B) is produced. As described above, for this purpose, preference is given to producing a homogenous mixture of the carbon composite material (A) with the sulfur. For this purpose, components (A) and (B) are comminuted either separately from one another or directly together to give a powder. In order to obtain a sulfur-carbon composite material from the mixture of components (A) and (B), the mixture is preferably treated thermally. Particular preference is given to heating components (A) and (B) together at a temperature in the range from 100 to 200° C. Process step (iii) can be performed either in a closed system, such as an autoclave, or in an open system, such as a flask, the material in the open system preferably being protected by blanketing with a stream of an inert gas, such as argon.

In one embodiment of the present invention, a feature of the process according to the invention for producing a sulfur-carbon composite material is that the production of the mixture in process step (iii) involves heating the carbon composite material and the elemental sulfur together at a temperature in the range from 100 to 200° C. A mixture thus produced is a composite material in which the starting materials can no longer be separated completely from one another by manual methods.

More particularly, the process according to the invention is suitable for industrial production of sulfur-carbon composite materials in continuous and/or batchwise mode. In batchwise mode, this means batch sizes exceeding 10 kg, better >100 kg, even more ideally >1000 kg or >5000 kg. In continuous mode, this means production rates exceeding 100 kg/day, better >1000 kg/day, even more ideally >10 t/day or >100 t/day.

The inventive sulfur-carbon composite materials obtained in the process according to the invention are typically comminuted further by subsequent comminution steps known to those skilled in the art to a pulverulent form, which can ultimately be used as an essential constituent of cathode materials for electrochemical cells, especially lithium-sulfur cells.

The present invention further also provides a cathode material for an electrochemical cell, comprising at least one inventive sulfur-carbon composite material as described above, and optionally at least one binder (C). The inventive cathode material preferably comprises, as well as the inventive sulfur-carbon composite material, at least one binder (C).

The at least one binder (C) present in the inventive cathode material serves principally for mechanical stabilization of inventive cathode material.

In one embodiment of the present invention, binder (C) is selected from organic (co)polymers. Examples of suitable organic (co)polymers may be halogenated or halogen-free. Examples are polyethylene oxide (PEO), cellulose, carboxymethyl cellulose, polyvinyl alcohol, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partly neutralized with alkali metal salt or ammonia, ethylene-methacrylic acid copolymers, optionally at least partially neutralized with alkali metal salt or ammonia, ethylene-(meth)acrylic ester copolymers, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

The mean molecular weight M_{w} of binders (C) can be selected within wide limits, a suitable example being 20 000 g/mol to 1 000 000 g/mol.

In one embodiment of the present invention, the inventive cathode material comprises in the range from 0.1 to 10% by weight of binder, preferably 1 to 8% by weight and more preferably 3 to 6% by weight, based on the mass of the inventive sulfur-carbon composite material used.

Binder (C) can be incorporated by various methods into inventive cathode material. For example, it is possible to dissolve soluble binders (C) such as polyvinyl alcohol in a suitable solvent or solvent mixture, water/isopropanol being a suitable example for polyvinyl alcohol, and to produce a suspension with the further constituents of the cathode material. After application to a suitable substrate, for example an aluminum foil, the solvent or solvent mixture is removed, for example vaporized, to obtain an electrode composed of the inventive cathode material. A suitable solvent for polyvinylidene fluoride is NMP.

If it is desirable to use sparingly soluble polymers as binder (C), for example polytetrafluoroethylene or tetrafluoroethylene-hexafluoropropylene copolymers, a suspension of particles of the binder (C) in question and the further constituents of the cathode material is produced and hot compressed.

As well as the inventive sulfur-carbon composite material and the binder (C), the inventive cathode material may additionally comprise carbon (D), which may in principle also be above-described carbon composite (A), except that it has not been contacted with sulfur. The additional carbon (D) is preferably carbon in a polymorph comprising at least 60% sp²-hybridized carbon atoms, preferably from 75% to 100% sp²-hybridized carbon atoms. In the context of the present invention, this carbon is also called carbon (D) for short and is known as such. The carbon (D) is an electrically conductive polymorph of carbon. Carbon (D) may be selected, for example, from graphite, carbon black, carbon nanotubes, graphene or mixtures of at least two of the aforementioned substances.

Figures in % are based on all the carbon (D) present together with the sulfur-carbon composite material in the cathode material, including any impurities, and mean percent by weight.

In one embodiment of the present invention, carbon (D) is carbon black. Carbon black may be selected, for example, from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, carbon (D) is partially oxidized carbon black.

In one embodiment of the present invention, carbon (D) comprises carbon nanotubes. Carbon nanotubes (CNTs for short), for example single-wall carbon nanotubes (SW CNTs) and preferably multiwall carbon nanotubes (MW CNTs), are known per se. A process for production thereof and some properties are described, for example, by A. Jess et al. in Chemie Ingenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

Carbon nanotubes can be produced by processes known per se. For example, it is possible to decompose a volatile carbon compound, for example methane or carbon monoxide, acetylene or ethylene, or a mixture of volatile carbon compounds, for example synthesis gas, in the presence of one or more reducing agents, for example hydrogen and/or a further gas, for example nitrogen. Another suitable gas mixture is a mixture of carbon monoxide with ethylene. Suitable temperatures for decomposition are, for example, in the range from 400 to 1000° C., preferably 500 to 800° C. Suitable pressure conditions for the decomposition are, for example, in the range from standard pressure to 100 bar, preferably to 10 bar.

Single- or multiwall carbon nanotubes can be obtained, for example, by decomposition of carbon compounds in a light arc, in the presence or absence of a decomposition catalyst.

In one embodiment, the decomposition of volatile carbon compounds or of carbon compounds is performed in the presence of a decomposition catalyst, for example Fe, Co or preferably Ni.

In the context of the present invention, graphene is understood to mean almost ideally or ideally two-dimensional hexagonal carbon crystals of analogous structure to individual graphite layers.

In a preferred embodiment of the present invention, carbon (D) is selected from graphite, graphene, activated carbon and especially carbon black.

Carbon (D) may, for example be in the form of particles having a diameter in the range from 0.02 to 50 μm. The particle diameter is understood to mean the mean diameter of the secondary particles, determined as the volume average by means of scanning electron micrographs.

In one embodiment of the present invention, carbon (D) and especially carbon black has a BET surface area in the range from 20 to 1500 m²/g, measured to ISO 9277.

In the context of the present invention, it is also possible, instead of one kind of carbon (D), to mix at least two, for example two or three, different kinds of carbon (D) with one another. Different kinds of carbon (D) may differ, for example, with regard to particle diameter or BET surface area or extent of contamination.

In one embodiment of the present invention, inventive cathode material comprises in the range from 20 to 80% by weight, preferably 30 to 70% by weight, of sulfur, determined by elemental analysis.

In one embodiment of the present invention, inventive electrode material comprises in the range from 0.1 to 60% by weight of carbon (D), preferably 3 to 30% by weight. This carbon can likewise be determined, for example, by elemental analysis, in which case the evaluation of the elemental analysis must take into account the fact that carbon is also introduced into inventive cathode material via components (A), (B) and (C).

Inventive sulfur-carbon composite materials and inventive cathode materials are particularly suitable as or for production of cathodes, especially for production of cathodes of lithium-containing batteries. The present invention provides for the use of inventive sulfur-carbon composite materials or inventive cathode materials as or for production of cathodes for electrochemical cells.

A further feature of inventive sulfur-carbon composite materials or inventive cathode materials is that it is possible in accordance with the invention to produce battery cells which are preferably stable over at least 30 cycles, more preferably over at least 50 cycles, even more preferably over at least 100 cycles, especially over at least 200 cycles or over at least 500 cycles.

The present invention further provides electrochemical cells comprising at least one cathode which has been produced from or using at least one inventive sulfur-carbon composite material or at least one inventive cathode material.

In the context of the present invention, that electrode which has reducing action in the course of discharging (work) is referred to as the cathode.

In one embodiment of the present invention, inventive sulfur-carbon composite material or inventive cathode material is processed to cathodes, for example in the form of continuous belts which are processed by the battery manufacturer.

Cathodes produced from inventive sulfur-carbon composite material or inventive cathode material may have, for example, thicknesses in the range from 20 to 500 μm, preferably 40 to 200 μm. They may, for example, be in the form of rods, in the form of round, elliptical or square columns or in cuboidal form, or in the form of flat cathodes.

In one embodiment of the present invention, inventive electrochemical cells comprise, as well as inventive sulfur-carbon composite material or inventive cathode material, at least one electrode comprising metallic magnesium, metallic aluminum, metallic zinc, metallic sodium or preferably metallic lithium.

In a further embodiment of the present invention, above-described inventive electrochemical cells comprise, as well as inventive sulfur-carbon composite material or inventive cathode material, a liquid electrolyte comprising a lithium-containing conductive salt.

In one embodiment of the present invention, inventive electrochemical cells comprise, as well as inventive sulfur-carbon composite material or inventive cathode material and a further electrode, especially an electrode comprising metallic lithium, at least one nonaqueous solvent which may be liquid or solid at room temperature and is preferably liquid at room temperature, and which is preferably selected from polymers, cyclic or noncyclic ethers, cyclic or noncyclic acetals, cyclic or noncyclic organic carbonates and ionic liquids.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably doubly methyl- or ethyl-capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

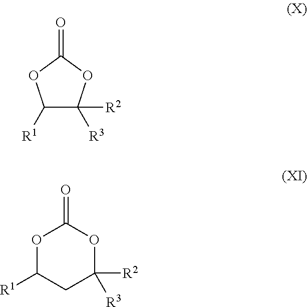

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

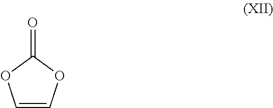

Preference is given to using the solvent(s) in what is called the anhydrous state, i.e. with a water content in the range from 1 ppm to 0.1% by weight, determinable, for example, by Karl Fischer titration.

In one embodiment of the present invention, inventive electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

In one embodiment of the present invention, inventive electrochemical cells comprise one or more separators by which the electrodes are mechanically separated from one another. Suitable separators are polymer films, especially porous polymer films, which are unreactive toward metallic lithium and toward lithium sulfides and lithium polysulfides. Particularly suitable materials for separators are polyolefins, especially porous polyethylene films and porous polypropylene films.

Polyolefin separators, especially of polyethylene or polypropylene, may have a porosity in the range from 35 to 45%. Suitable pore diameters are, for example, in the range from 30 to 500 nm.

In another embodiment of the present invention, the separators selected may be separators composed of PET nonwovens filled with inorganic particles. Such separators may have a porosity in the range from 40 to 55%. Suitable pore diameters are, for example, in the range from 80 to 750 nm.

The inventive electrochemical cells can be assembled to lithium ion batteries.

Accordingly, the present invention also further provides for the use of inventive electrochemical cells as described above in lithium ion batteries.

The present invention further provides lithium ion batteries comprising at least one inventive electrochemical cell as described above. Inventive electrochemical cells can be combined with one another in inventive lithium ion batteries, for example in series connection or in parallel connection. Series connection is preferred.

Inventive electrochemical cells are notable for particularly high capacities, high performances even after repeated charging and greatly retarded cell death. Inventive electrochemical cells are very suitable for use in motor vehicles, bicycles operated by electric motor, for example pedelecs, aircraft, ships or stationary energy stores. Such uses form a further part of the subject matter of the present invention.

The present invention further provides for the use of inventive electrochemical cells as described above in automobiles, bicycles operated by electric motor, aircraft, ships or stationary energy stores.

The use of inventive lithium ion batteries in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The present invention therefore also further provides for the use of inventive lithium ion batteries in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The present invention also provides for the use of a carbon composite material comprising
(a) a carbonization product of at least one carbonaceous starting material, incorporating
(aa) particles of at least one electrically conductive additive, the particles having an aspect ratio of at least 10,
   for production of an electrochemical cell, more preferably for production of an electrode for an electrochemical cell, even more preferably for production of a cathode for an electrochemical cell, especially for production of a sulfur cathode for a lithium-sulfur cell.

The description and preferred embodiments of the carbon composite material, of the carbonaceous starting material, of the carbonization product (a) and of the particles (aa) correspond to the above description of these components for the inventive sulfur-carbon composite material.

The invention is explained by the examples which follow, but these do not limit the invention.

Figures in % relate to percent by weight, unless explicitly stated otherwise.

### I. Synthesis of Carbonization Products of at Least One Carbonaceous Starting Material

### I.1 Synthesis of an Inventive Carbon Composite Material C.1

30.7 g of corn starch (Aldrich) were mixed intimately with 0.76 g of MF-C110 carbon fibers (from Carbon-NT&F 21, A-7000 Eisenstadt) with the aid of a mortar and then pyrolyzed in a nitrogen-purged crucible at 600° C. for 2 h. Subsequently, the coarse grains of product obtained were triturated and ground at 300 rpm in a ball mill (Fritsch Pulverisette) for 10 min to give a fine powder (output 6.9 g).

### I.2 Synthesis of a Noninventive Carbonization Product V-C.2

30.8 g of corn starch (Aldrich) were pyrolyzed in a nitrogen-purged crucible at 600° C. for 2 h. Subsequently, the hard, shiny black, coarse grains of product were removed, weighed and triturated. There remained 6.05 g of fine powder which was ground and homogenized together with 0.75 g of MF-C110 carbon fibers (from Carbon-NT&F 21, A-7000 Eisenstadt) in a ball mill (Fritsch Pulverisette) at 300 rpm for 10 min.

### II. Synthesis of Sulfur-Carbon Materials

### II.1 Synthesis of an Inventive Sulfur-Carbon Composite Material SC.1

1 g of the material C.1 produced beforehand was mixed intimately with 6 g of sulfur (Aldrich) using a mortar and heat-treated at 180° C. in a nitrogen-purged, closed steel autoclave for 6 h. After cooling, the resulting sulfur-carbon composite material SC.1 was ground at 300 rpm in a ball mill (Fritsch Pulverisette) for 10 min. Finally, the sulfur content of the gray material SC.1 was determined by means of elemental analysis and a value of 84.2% was found.

### II.2 Synthesis of a Noninventive Sulfur-Carbon Material V-SC.2

1 g of the material V-C.2 produced beforehand was mixed with 6 g of sulfur using a mortar and heat-treated at 180° C. in a nitrogen-purged, closed steel autoclave for 6 h.

After cooling, the resulting grayish sulfur-carbon material V-SC.2 was ground at 300 rpm in a ball mill (Fritsch Pulverisette) for 10 min. Finally, the sulfur content in V-SC.2 was determined by means of elemental analysis and a value of 83% was found.

### III. Production of Cathodes

III.1 Production of an Inventive Cathode K.1 from SC.1

To produce a slurry of the cathode material, 0.295 g of carbon black (Super P, commercially available from Timcal AG, 6743 Bodio, Switzerland) and 0.050 g of polyvinyl alcohol (Celvol425, commercially available from Celanese Corporation, USA) were added to a suspension of 0.655 g of SC.1 in approx. 10 ml of water/isopropanol (1:1). For dispersion, the mixture was transferred to a stainless steel grinding vessel and then a ball mill (Pulverisette from Fritsch) was used, stirring with stainless steel balls at 300 rpm for 30 min. After the dispersion, a very homogeneous slurry with creamy consistency was formed (by adding small amounts of water/isopropanol, the desired concentration was established in individual cases). The slurry was applied to aluminum foil using a manual coating bar (gap width 140 μm). Subsequently, the moist electrode tape was dried under reduced pressure in a drying cabinet at 40° C. overnight. A solids loading of 2.53 mg/cm² was achieved. From the starting weight, a theoretical sulfur content of 55% in the cathode was calculated.

III.2 Production of a Noninventive Comparative Cathode V-K.2 from V-SC.2

To produce a slurry of the cathode material, 0.294 g of carbon black (Super P, commercially available from Timcal AG, 6743 Bodio, Switzerland) and 0.051 g of polyvinyl alcohol (Celvol425, commercially available from Celanese Corporation, USA) were added to a suspension of 0.655 g of V-SC.2 in approx. 10 ml of water/isopropanol (1:1). For dispersion, the mixture was transferred to a stainless steel grinding vessel and then a ball mill (Pulverisette from Fritsch) was used, stirring with stainless steel balls at 300 rpm for 30 min. After the dispersion, a very homogeneous slurry with creamy consistency was formed (by adding small amounts of water/isopropanol, the desired concentration was established in individual cases). The slurry was applied to aluminum foil using a manual coating bar (gap width 140 μm). Subsequently, the moist electrode tape was dried under reduced pressure in a drying cabinet at 40° C. overnight. A solids loading of 2.51 mg/cm² was achieved. From the starting weight, a theoretical sulfur content of 55% in the cathode was calculated.

### IV. Testing of the Cathodes in Electrochemical Cells

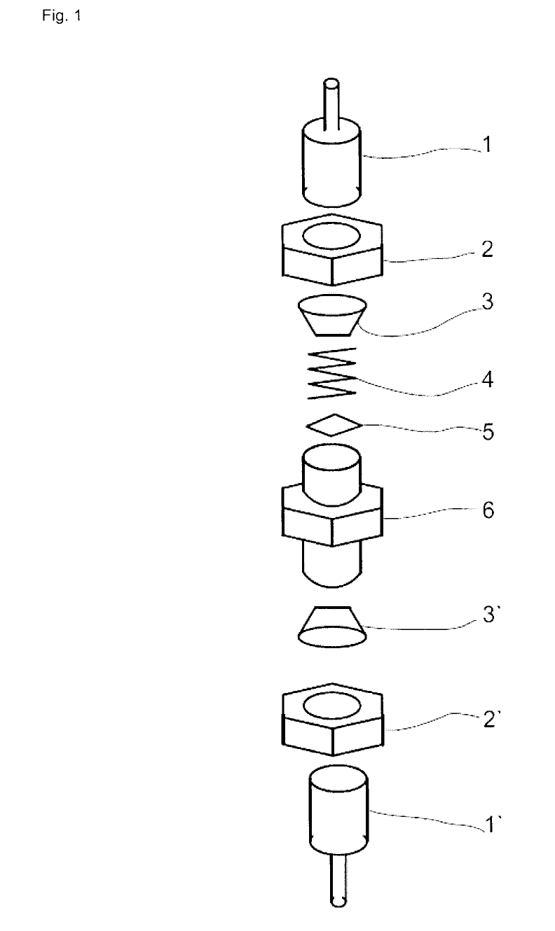

For the electrochemical characterization of the inventive cathode K.1 and of the comparative cathode V-K.2, electrochemical cells were constructed according to FIG. 1. For this purpose, as well as the cathodes produced in III, the following components were used in each case:
Anode: Li foil, thickness 50 μm,
Separator: microporous, three-ply membrane (PP/PE/PP) of thickness 38 μm (commercially available as Celgard® 2340)
Cathode: according to example III.
Electrolyte: 1 M LiTFSI (LiN(SO₂CF₃)₂) in 1:1 mixture of dioxolane and dimethoxyethane

FIG. 1 shows the schematic structure of a dismantled electrochemical cell for testing of inventive and noninventive composite materials.

The annotations in FIG. 1 mean:
1, 1′ bolts
2, 2′ nuts
3, 3′ sealing ring—two in each case, the second, somewhat smaller sealing ring in each case is not shown here
4 spiral spring
5 nickel output conductor
6 housing

The charging and discharging of the respective electrochemical cell was performed alternately with a relative current (based on the cathode area) of 0.45 mA/cm² (charging) and 0.70 mA/cm² (discharging) between the voltage limits of 1.8 and 2.5 V. The resulting test results of the two electrochemical cells are summarized in table 1.

TABLE 1
Test results of inventive and noninventive electrochemical cells

| | Discharge | Discharge | Discharge | Discharge |
|---|---|---|---|---|
| | capacity | capacity | capacity | capacity |
| | 5th cycle | 30th cycle | 50th cycle | 70th cycle |
| Example | [mA · h/g S] | [mA · h/g S] | [mA · h/g S] | [mA · h/g S] |
| Cathode K.1 | 1150 | 1125 | 1100 | 900 |
| based on SC.1 | | | | |
| Cathode V-K.2 | 1125 | 1100 | (cell | 0 |
| based on | | | collapses) | |
| V-SC.2 | | | | |

1. A sulfur-carbon composite material, comprising:
a carbon composite material and
elemental sulfur,
wherein the carbon composite material comprises a carbonization product of a carbonaceous starting material,
the carbonaceous starting material comprises particles of at least one electrically conductive additive, and
the particles have an aspect ratio of at least 10.

2. The sulfur-carbon composite material according to claim 1,
wherein the carbonaceous starting material is at least one selected from the group consisting of a carbohydrate, a resin, coke, pitch, polyacrylonitrile, a styrene-acrylonitrile copolymer, a melamine-formaldehyde resin, and a phenol-formaldehyde resin.

3. The sulfur-carbon composite material according to claim 1, wherein the particles have a mean diameter of from 50 nm to 100 μm.

4. The sulfur-carbon composite material according to claim 1, wherein the particles of have an electrical conductivity of from 0.1 mS/cm to 30,000 S/cm.

5. The sulfur-carbon composite material according to claim 1,
wherein the particles are carbon fibers, fibers of transparent indium tin oxide, fibers of transparent Al-doped zinc oxide, fibers of transparent Ga-doped zinc oxide, fibers of transparent In-doped zinc oxide, fibers of transparent F-doped tin dioxide, fibers of transparent Sb-doped tin dioxide, fibers of WC, fibers of MoC, fibers of TiC, aluminum fibers, or steel fibers.

6. The sulfur-carbon composite material according to claim 1, wherein a proportion by weight of the particles, based on a total weight of the carbon composite material, is from 0.1 to 60% by weight.

7. The sulfur-carbon composite material according to claim 1, wherein a proportion by weight of the sulfur, based on a sum of proportions by weight of the carbon composite material and of the sulfur, is from 10 to 95% by weight.

8. The sulfur-carbon composite material according to claim 1, wherein the sulfur-carbon composite material is particulate.

9. A process for producing the sulfur-carbon composite material according to claim 1, the process comprising:
producing a mixture comprising a carbonaceous starting material and particles of an electrically conductive additive, the particles having an aspect ratio of at least 10,
carbonizing the carbonaceous starting material to form a carbonization product comprising particles of an electrically conductive additive, thereby obtaining a carbon composite material, and
producing a mixture of the carbon composite material and elemental sulfur.

10. The process according to claim 9, wherein a temperature of the carbonizing is at least 500° C.

11. The process according to claim 9, wherein producing the mixture of the carbon composite material and the elemental sulfur comprises heating the carbon composite material and the elemental sulfur together at a temperature of from 100 to 200° C.

12. A cathode material comprising:
the sulfur-carbon composite material according to claim 1, and
optionally a binder,
wherein the cathode material is suitable for an electrochemical cell.

13. An electrochemical cell, comprising:
a cathode produced from or a with the sulfur-carbon composite material according to claim 1.

14. The electrochemical cell according to claim 13, further comprising an electrode comprising metallic lithium.

15. The electrochemical cell according to claim 13, further comprising a liquid electrolyte comprising a conductive salt that comprises lithium.

16. The electrochemical cell according to claim 13, further comprising at least one nonaqueous solvent selected from the group consisting of a polymer, a, cyclic or noncyclic ether, a noncyclic or cyclic acetal, and a cyclic or noncyclic organic carbonate.

17. A process of producing a lithium ion battery, the process comprising:
producing a lithium ion battery with the electrochemical cell according to claim 1.

18. A lithium ion battery, comprising the electrochemical cell according to claim 13.

19. A motor vehicle, a bicycle operated by electric motor, an aircraft, a ship, or a stationary energy store, comprising the electrochemical cell of claim 13.

20. A process of producing an electrochemical cell, the process comprising:
producing an electrochemical cell with a carbon composite material,
wherein the carbon composite material comprises a carbonization product of a carbonaceous starting material,
the carbonaceous starting material comprises particles of an electrically conductive additive, and
the particles have an aspect ratio of at least 10.
